(19) United States
(12) Patent Application Publication
(10) Pub. No.: US 2015/0206206 A1
(43) Pub. Date: Jul. 23, 2015

(54) SYSTEMS AND METHODS FOR FLEXIBLE VEHICLE SHARING

(71) Applicant: Cox Enterprises, Inc., Atlanta, GA (US)

(72) Inventors: Jose Puente, Atlanta, GA (US); Marian Pittman, Atlanta, GA (US); Ed Shrum, Atlanta, GA (US); Rich Coutu, Atlanta, GA (US); Steve Rosenboro, Atlanta, GA (US)

(21) Appl. No.: 14/604,166

(22) Filed: Jan. 23, 2015

Related U.S. Application Data
(60) Provisional application No. 61/930,897, filed on Jan. 23, 2014.

(51) Int. Cl. G06Q 30/02; G06Q 30/06

(52) U.S. Cl. CPC G06Q 30/0283; G06Q 30/0645

(57) ABSTRACT

Systems and methods are provided for vehicle sharing. Methods may include receiving a vehicle use request comprising a selection of a first vehicle, a first user identifier, and a first vehicle use timeframe indicator, and identifying a driving behavior profile for the first user indicative of historical driving behavior of the first user comprising speed data, braking data, and user feedback data. The method may include generating a first vehicle use price indicative of a total cost for the desired length of vehicle usage time based at least in part on the driving behavior profile, and receiving acceptance of the first vehicle use price from the first user device. The method may include sending an activation signal to the selected first vehicle, and monitoring driving behavior of the first user by receiving vehicle operation data from the selected first vehicle, the vehicle operation data comprising speed data and braking data.

### CROSS-REFERENCE TO RELATED APPLICATIONS

This patent application claims the benefit of U.S. Provisional Patent Application No. 61/930,897, filed Jan. 23, 2014, and titled “SYSTEMS AND METHODS FOR FLEXIBLE VEHICLE SHARING”, which is hereby incorporated by reference in its entirety.

### TECHNICAL FIELD

The present disclosure generally relates to vehicle sharing across multiple retailers, fleet providers, and/or consumers.

### BACKGROUND

Recently, more and more consumer models for possessing vehicles have emerged. In certain instances, entities, such as vehicle fleet companies and/or groups of individuals, may allow for consumers to drive their vehicles for an extended period of time without taking ownership and/or lease of the vehicles. Instead, these entities may simply charge the consumers a fee for driving their vehicles. However, the types of vehicles and the associated pricing schemes offered by the entities may be relatively limited.

### BRIEF DESCRIPTION OF THE DRAWINGS

Reference will now be made to the accompanying figures and diagrams, which are not necessarily drawn to scale, and wherein:

FIG. 1 shows a system for flexible vehicle sharing according to one or more example embodiments.

FIG. 2 shows another system diagram related to flexible vehicle sharing according to one or more example embodiments.

FIG. 3 shows a system diagram one or more components included in a vehicle for flexible vehicle sharing, according to one or more example embodiments.

FIG. 4 shows a block diagram for flexible vehicle sharing, according to one or more example embodiments.

FIG. 5 shows a flow diagram of a method for flexible vehicle sharing, according to one or more example embodiments.

FIG. 6 shows a flow diagram of another method for flexible vehicle sharing, according to one or more example embodiments.

FIG. 7 shows a flow diagram of a method for flexible vehicle sharing, according to one or more example embodiments.

FIG. 8 shows another embodiment of a system for flexible vehicle sharing according to one or more example embodiments.

FIG. 9 shows example user interfaces of a user device of the system of FIG. 8, according to one or more example embodiments.

FIG. 10 shows example user interfaces during a vehicle swapping interaction between two users, according to one or more example embodiments.

FIG. 11 shows a flow diagram of another method for flexible vehicle sharing, according to one or more example embodiments.

FIG. 12 shows a flow diagram of yet another method for flexible vehicle sharing, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “consumer device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer, cloud computer/thin client), a portable media player, a personal digital assistant (PDA), a kiosk computer for public use, set top box, gaming system, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include social networking web pages. Another example of a server may be a cloud server that hosts web services for one or more computer devices.

As used herein, unless otherwise specified, the term “web page” may correspond to one or more web pages as part of one or more websites.

According to one or more embodiments of the disclosure, a method is provided. The method may include receiving, from a retailer computer, by a service provider computer comprising one or more processors, one or more vehicle identifiers associated with one or more selected vehicles to be made available to a flexible vehicle sharing program. The method may also include determining, based at least in part on one or more vehicle attributes associated with the one or more vehicle identifiers, a recommended vehicle identifier of the one or more vehicle identifiers, to provide to the flexible vehicle sharing program. The method may further include transmitting, to the retailer computer, the recommended vehicle identifier. Additionally, the method may include receiving, from the retailer computer, a selection of the recommended vehicle identifier to participate in the flexible vehicle sharing program.

According to one or more embodiments of the disclosure, a system is provided. The system may have at least one processor and at least one memory storing computer-readable instructions. When the instructions are executed by the at least one processor, the instructions may cause the at least one processor to receive, from a retailer computer, one or more vehicle identifiers associated with one or more selected vehicles to be made available to a flexible vehicle sharing program. The instructions may further cause the at least one processor to determine, based at least in part on one or more vehicle attributes associated with the one or more vehicle identifiers, a recommended vehicle identifier of the one or more vehicle identifiers, to provide to the flexible vehicle sharing program. Moreover, the instructions may cause the at least one processor to transmit, to the retailer computer, the recommended vehicle identifier. The instructions may further cause the at least one processor to receive, from the retailer computer, a selection of the recommended vehicle identifier to participate in the flexible vehicle sharing program.

According to one or more embodiments of the disclosure, a non-transitory computer-readable medium is provided. The non-transitory computer-readable medium may have embodied thereon instructions executable by one or more processors. The instructions may cause the one or more processors to receive, from a retailer computer, one or more vehicle identifiers associated with one or more selected vehicles to be made available to a flexible vehicle sharing program. Furthermore, the instructions may cause the one or more processors to determine, based at least in part on one or more vehicle attributes associated with the one or more vehicle identifiers, a recommended vehicle identifier of the one or more vehicle identifiers, to provide to the flexible vehicle sharing program. Additionally, the instructions may cause the one or more processors to transmit, to the retailer computer, the recommended vehicle identifier. The instructions may also cause the one or more processors to receive, from the retailer computer, a selection of the recommended vehicle identifier to participate in the flexible vehicle sharing program.

According to one or more embodiments of the disclosure, a method is provided. The method may include receiving, by a computer system comprising one or more processors and a memory, a first vehicle use request from a first user device associated with a first user, the first vehicle use request comprising a selection of a first vehicle from a set of one or more available vehicles, a first user identifier associated with the first user, and a first vehicle use timeframe indicator indicative of a desired length of vehicle usage time for the selected first vehicle. The method may include identifying, by the computer system, a driving behavior profile for the first user based at least in part on the first user identifier, the driving behavior profile indicative of historical driving behavior of the first user comprising speed data, braking data, and user feedback data. The method may include generating, by the computer system, a first vehicle use price indicative of a total cost for the desired length of vehicle usage time for the selected first vehicle based at least in part on the driving behavior profile. The method may include receiving, by the computer system, an indication of acceptance of the first vehicle use price from the first user device, and sending, by the computer system, an activation signal to the selected first vehicle, the activation signal configured to facilitate access to and operation of the selected first vehicle by the first user. The method may include monitoring, by the computer system, driving behavior of the first user by receiving vehicle operation data from the selected first vehicle, the vehicle operation data comprising speed data and braking data. Other data may include location data, road condition data, acceleration data, highway/city driving data, and mileage data.

According to one or more embodiments of the disclosure, a method is provided. The method may include identifying, by a computer system comprising one or more processors and a memory, a set of vehicles available for exchange, and receiving, by the computer system, a vehicle exchange request from a first user device associated with a first user, the vehicle exchange request comprising a first user identifier indicative of the first user, a first vehicle identifier indicative of a first vehicle in use by the first user, and a second vehicle identifier indicative of a second vehicle desired by the first user, wherein the first vehicle identifier is associated with the first user and the second vehicle identifier is associated with a second user. The method may include sending, by the computer system, vehicle exchange information to a second user device associated with the second user, the vehicle exchange information comprising the first user identifier and the first vehicle identifier. The method may include receiving, by the computer system, a vehicle exchange approval notification from the second user device indicating the second user approves the exchange of the second vehicle for the first vehicle, and sending, by the computer system, an indication of the vehicle exchange approval notification to the first user device. In some embodiments, the second user may be able to request return of the second vehicle from the first user. In such embodiments, the second user may select a third vehicle to operate upon return of the second vehicle. Accordingly, vehicle exchanges may not be direct or one-for-one exchanges, as an entirely different third vehicle may be included. The systems described herein may notify the first and second users when the switch or exchange is available based on when the third vehicle is ready for pick up by the second user.

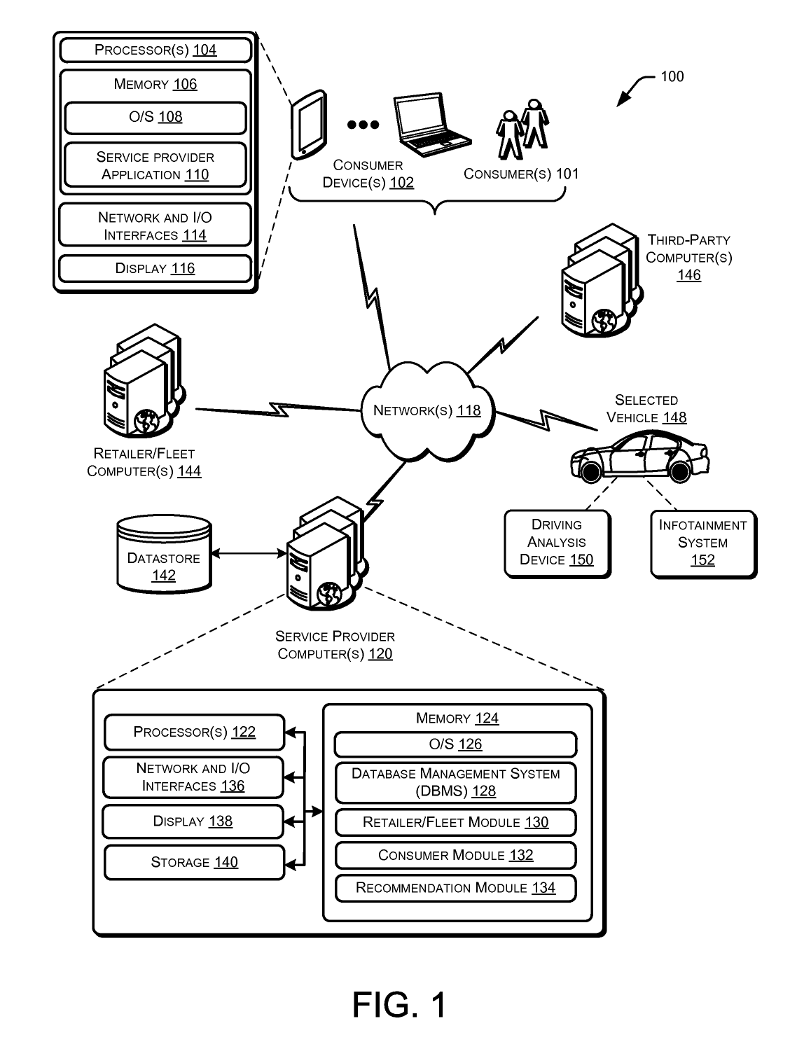

The above principles, and perhaps others, are now illustrated with reference to FIG. 1, which depicts a system 100 for providing flexible vehicle sharing. The system 100 may include one or more consumer devices 102 associated with one or more consumers, such as consumers 101. The consumer device(s) 102 may be in communication with, via one or more network(s) 118, one or more service provider computer(s) 120, one or more retailer computers 144, one or more third-party service provider computers 146, and one or more vehicles 148 having respective driving analysis devices 150 and infotainment systems 152.

In general, the consumer device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The consumer device(s) 102 may include one or more computer processors 104, and a memory 106 storing an operating system (0/S) 108 and a service provider application 110. In addition, the consumer device(s) 102 may include one or more network and I/O interfaces 114, and a display 116. In certain embodiments, the consumer device(s) 102 may include one or more sensors capable of gathering information associated with a present environment of the consumer device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The consumer device 102 may also include a chipset (not shown) for controlling communications between the one or more processors 104 and one or more of the other components of the consumer device 102. In certain embodiments, the consumer device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the consumer device 102. The memory 106 may also store content that may be displayed by the consumer device 102 or transferred to other devices (e.g., headphones) to be displayed or played by the other devices. The memory 106 may also store content received from the other devices. The content from the other devices may be displayed, played, or used by the consumer device 102 to perform any necessary tasks or operations that may be implemented by the computer processor or other components in the consumer device 102.

The memory 106 may also include an operating system (O/S) 108, which may provide an interface between other application software executing on the consumer device 102 and hardware resources of the consumer device 102. More specifically, the operating system 108 may include a set of computer-executable instructions for managing hardware resources of the consumer device 102 and for providing common services to other application programs (e.g., managing memory allocation among various application programs). The operating system 108 may include any operating system now known or which may be developed in the future including, but not limited to, any consumer operating system, any server operating system, any mainframe operating system, or any other proprietary or freely available operating system.

The memory 106 may also include a service provider application 110, which may be configured to enable a consumer's access to one or more services offered by a service provider (e.g., via the service provider server(s)). In certain embodiments, such services may include a flexible vehicle sharing program. The flexible vehicle sharing program may enable a consumer 101 to select one or more vehicles to drive for a subscription fee. For instance, instead of outright purchasing and owning a vehicle, a consumer 101 may pay a monthly fee to the flexible vehicle sharing program to drive vehicles offered by the program. The type of vehicles available to the consumer 101 may depend in part on the amount of the subscription fee paid by the consumer 101. For instance, one or more vehicle sharing tiers may be offered by the flexible vehicle sharing program, and different tiers may be associated with different prices and different available vehicles for the consumer 101 to select. Furthermore, membership in the flexible vehicle sharing program may be shared among one or more consumers 101. For instance, a selected vehicle may be driven by more than one consumer 101 (e.g., multiple people of the same family and/or household) for the price of a single membership.

In some embodiments, once the consumer 101 has selected a particular vehicle to drive, the flexible vehicle sharing program may collect the consumer's delivery instructions to facilitate and/or provide delivery of the vehicle to the consumer 101. In other embodiments, the flexible vehicle sharing program may indicate a location at which the consumer 101 may pick up the vehicle. For example, the flexible vehicle sharing program may provide an address and/or a visual representation of the pickup location on a map. Furthermore, in situations where the consumer 101 has previously checked out a vehicle from the flexible vehicle sharing program, the flexible vehicle sharing program may arrange (e.g., via the service provider application and/or the service provider computer(s) 120) collection of the previous vehicle. For instance, the collection may be made at the same time the newly selected vehicle is being delivered to the consumer. Alternatively, the consumer 101 may be instructed to drop of the previous vehicle at the same location the consumer 101 is picking up the newly selected vehicle.

In other embodiments, the operation and actions performed by the service provider application 110 may instead performed via a web browser. For instance, the consumer 101 may use the web browser to interface with web pages service by the service provider computer(s) 120 to register with and/or otherwise perform actions related to the flexible vehicle sharing program

Referring again to the consumer device 102, the one or more network and I/O interfaces 114 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the consumer device 102 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 116 may include, but is not limited to, a liquid crystal display, a light-emitted diode display, or an E-Ink™ display as made by E Ink Corp. of Cambridge, Mass. The display 116 may be used to show content to a user in the form of text, images, or video. In certain instances, the display 116 may also operate as a touch screen display that may enable the user to initiate commands or operations by touching the screen using certain finger or hand gestures.

With continued reference to FIG. 1, one or more service provider computer(s) 120 may also be in communication with the network(s) 118. The service provider computer(s) 120 may also include processor(s) 122 and memory 124, which may store an operating system (0/S) 126, a database management system (DBMS) 128, a retailer module 130, a consumer module 132, and a recommendation module 134.

The computer processors 122 may comprise one or more cores and may be configured to access and execute (at least in part) computer-readable instructions stored in the memory 124. The one or more computer processors 122 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The service provider computer 120 may also include a chipset (not shown) for controlling communications between the one or more processors 122 and one or more of the other components of the service provider computer 120. In certain embodiments, the service provider computer 120 may be based on an Intel® architecture or an ARM® architecture, and the processor(s) and chipset may be from a family of Intel® processors and chipsets. The one or more processors 122 may also include one or more application-specific integrated circuits (ASICs) or application-specific standard products (ASSPs) for handling specific data processing functions or tasks.

The memory 124 may include one or more computer-readable storage media (CRSM). In some embodiments, the memory 124 may include non-transitory media such as random access memory (RAM), flash RAM, magnetic media, optical media, solid state media, and so forth. The memory 124 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 126 that includes a plurality of computer-executable instructions that may be implemented by the computer processor to perform a variety of tasks to operate the interface(s) and any other hardware installed on the service provider computer 120. The memory 124 may also store content that may be displayed by the service provider computer 120 or transferred to other devices (e.g., headphones) to be displayed or played by the other devices. The memory 124 may also store content received from the other devices. The content from the other devices may be displayed, played, or used by the service provider computer 120 to perform any necessary tasks or operations that may be implemented by the computer processor or other components in the service provider computer 120.

The DBMS 128 stored in memory 124 may be configured to support functionality for accessing, retrieving, storing, and/or manipulating data stored in external datastore(s) (e.g., service provider datastore 142), data stored in the memory 124, and/or data stored in the data storage 140. The DBMS 128 may use any of a variety of database models (e.g., relational model, object model, etc.) and may support any of a variety of query languages.

According to one or more embodiments, the DBMS 128 may be configured to store, retrieve, and/or otherwise access various data related to the flexible vehicle sharing program from the service provider datastore 142. For example, the DBMS 128 may be configured to retrieve and/or or store account data associated with a consumer 101 and or a vehicle retailer. Furthermore, the service provider datastore 142 may store information related to vehicle inventory associated with multiple vehicle retailers (e.g., dealers, original equipment manufacturers (OEMs), rental car companies, etc.). Such information may include data associated with vehicle wholesale market and/or retail markets in various geographical regions. Based at least in part on such data, the service provider computer 120 (e.g., via the retailer module 130 discussed below) may be capable of determining real-time, accurate calculations related to vehicle pricing, value, depreciation, supply, demand, residual, and various other vehicle attributes associated with the wholesale and/or retail markets. Furthermore, the service provider computer(s) 120 may also be configured to use such data to determine one or more projections related to the profitability, for a retailer, of keeping a particular vehicle in the flexible vehicle sharing program versus selling the vehicle, moving the vehicle to another geographic market, and/or other such projections.

The memory may also include a retailer module 130, a consumer module 132, and a recommendation module 134. The retailer module 130 may be configured to communicate with various retailers associated with one or more retailer computer(s) 144. As used herein, a retailer may refer to a dealer/dealership, an original equipment manufacturer, a rental car company, a finance company, a fleet company, and/or any other entity having an inventory of vehicles. In certain implementations, the retailer module 130 may be configured to receive registration information from a retailer in order to register with the flexible vehicle sharing program. Once registration is completed, the retailer module 130 may also be configured to receive, via the retailer computer 144 of the retailer, vehicle inventory information associated with the retailer computer 144. The vehicle inventory information may include various types of information related to vehicles in retailer's inventory. For instance, such information may include a make, model, year, mileage, vehicle identification number (VIN), retail price, the dealer's sunk costs in the vehicle, trim, options, geographic location, and/or the like. According to certain embodiments, the retailer module 130 may enable the retailer (e.g., via the retailer computer 144) to filter the retailer's inventory for particular vehicles to make available to the flexible vehicle sharing program. As such, the retailer computer 144 may also transmit one or more filtering instructions to the retailer module 130 of the service provider computer 120. The filtering instructions may include one or more selected vehicle attributes that designate which vehicle(s) of the retailer's inventory are to be available to the flexible vehicle sharing program. For instance, the retailer may desire that only vehicles of a certain make, model, price, etc. are to be made available to the flexible vehicle sharing program.

Furthermore, information associated with the retailer's inventory, the selected vehicles to be made available to the flexible vehicle sharing program, and/or any other type of data associated with the retailer may be stored by the service provider computer(s) 120 in a retailer profile. The retailer profile may be stored in the service provider datastore 142. For example, each retailer may be associated with a retailer identifier. Additionally, each retailer identifier may be associated with any of the above discussed information associated with the retailer, thereby creating a retailer profile. The service provide computer(s) 120 may also enable a retailer to view and/or otherwise access its retailer profile, and in certain instance, may allow the retailer to modify its retailer profile (e.g., change filtering options, change contact information, etc.).

Furthermore, according to other embodiments, the retailer module 130 may be configured to facilitate the purchase and/or negotiate insurance terms associated with vehicles that the retailer computer 144 provides to the flexible sharing program. Such negotiations may be based around group and/or individual insurance rates. The retailer module 130 may provide retailers the option to choose from multiple types of insurance plans. In other embodiments, the retailer module 130 may instead establish a standard insurance provided to all subscribed retailers.

According to one or more embodiments, the retailer computer 144 may be associated with a rental car company. Furthermore, the rental car company may select a particular vehicle from its inventory to participate in the flexible vehicle sharing program for a period of time. To this end, the retailer module 130 may be configured to periodically determine, in real-time or near real-time, information associated with one or more vehicle attributes of the selected vehicle (e.g., condition of the vehicle, mileage, residual value, costs incurred in the vehicle). Based at least in part on such information, the retailer module 130 may also be configured to determine one or more profitability projections associated with the selected vehicle. For instance, the profitability projections may indicate different profitability information depending on whether the vehicle is kept in the flexible vehicle sharing program, whether it is transferred back to the rental car company, and/or whether the vehicle is simply divested by the rental car company. With respect to determining whether to divest the vehicle, the retailer module 130 may request that the rental car company input certain parameters (e.g., mileage, age, etc.) indicating the condition of the vehicle at which the rental car company typically divests vehicles in its inventory.

In certain implementations, a retailer may actually be an individual vehicle owner who is also a consumer 101 of the flexible vehicle sharing program. For instance, the individual may desire to offer his/her vehicle to the flexible vehicle sharing program. In such situations, the individual may be presented with an interface similar to that of a normal retailer, and may be presented and/or have access to similar information about the offered vehicle as a normal retailer. Furthermore the individual may be presented an option to invite and or select particular consumer(s) 101 of the flexible vehicle sharing program that he/she is comfortable with driving the offered vehicle. To this end, the flexible vehicle sharing program enable a rating system to rate the reputations of drivers (e.g., consumers 101) registered in the program. A rating of a particular driver/consumer 101 may be determined based at least in part on driving habits, vehicle condition, timeliness of returning the vehicle, and/or any other type of information associated with the driver/consumer 101.

With continued reference to FIG. 1, the memory 124 of the service provider computer(s) 120 may also include a consumer module 132 to communicate and/or interface with the consumer device(s) 102. In certain implementations, the consumer module 132 may be configured to receive registration information from a consumer 101 in order to register with the flexible vehicle sharing program. Once registration is completed, the consumer module 132 may also be configured to receive, from the consumer device 102 of the consumer 101, a selection indicating an agreed upon pricing structure and/or subscription fee. The subscription fee may be associated with a set of one or more vehicles that the consumer may choose from to drive for a designated period of time (e.g., one week, one month, etc.). In certain embodiments, a particular set of vehicles may belong to a vehicle tier, and different tiers may be associated with different pricing structures and/or subscription fees. Dynamic pricing may be determined based at least in part on consumer rating, driving habits, usage history, driving locations (and their associated risks (e.g., accident rates, theft rates, damage rates, and so forth), associated insurance costs, and other factors.

Furthermore, the consumer module 132 may also be configured to receive, from the consumer device 102, one or more vehicle attributes that the consumer 101 may desire. For instance, such attributes may include a make, model, year, mileage, vehicle identification number, retail price, trim, options, geographic location, and/or the like. In other words, the consumer 101 may be able to filter for one or more vehicles in a particular vehicle tier, based at least in part on the selected attributes. Additionally, the consumer module 132 may be configured to receive, from the consumer device 102, a selection of a particular vehicle to drive. In response, the consumer module 132 may transmit a notification, to the consumer device 102, indicating that the consumer 101 is to receive delivery of the selected vehicle. Alternatively, the consumer module 132 may be configured to indicate, to the consumer 101 and/or consumer device 102, location information associated with a pickup location for the selected vehicle.

According to certain embodiments, the above information (e.g., the pricing/vehicle tiers, the filter options, the selected vehicle, and/or any other type of information associated with the consumer 101) may be stored in consumer profile associated with the consumer 101. The consumer profile may be stored in the service provider datastore 142. For example, each registered consumer may be associated with a consumer identifier. Additionally, each consumer identifier may be associated with any of the above discussed information, and these associations may be stored as a consumer profile. The service provide computer(s) 120 may also enable a consumer 101 to view and/or otherwise access its consumer profile, and in certain instance, may allow the consumer 101 to modify its consumer profile (e.g., change filtering options, pricing tier, selected vehicle, contact information, etc.).

In some embodiments, the consumer module 132 may be configured to store information associated with a selected vehicle history of the consumer 101. For instance the selected vehicle history may be stored in the consumer profile and may indicate the vehicles that the consumer 101 has previous selected to drive. As such, the consumer module 132 may be configured to determine, based at least in part on one or more vehicle attributes associated with the previous selected vehicles in vehicle history, one or more vehicle suggestions for the consumer 101 to select in the future. For example, if the consumer 101 has previously selected a BMW 3-series, the consumer module 132 may recommend the consumer 101 to select and Audio A4.

According to certain embodiments, the consumer(s) 101 may be individual persons desiring to register with the flexible vehicle sharing program. Alternatively, the consumer(s) 101 may include institutions or entities that include more than one person (e.g., corporate entities, apartment complexes, institutional facilities, business). These groups may desire to obtain one or more vehicles from the flexible vehicle sharing program to share amongst the members of the group (e.g., employees of a company). In certain implementations, each of the group members may be registered with the flexible vehicle sharing program, while in other implementations, the group may be able to share a single membership. If the group shares a single membership, the group may indicate, to the flexible vehicle sharing program (e.g., the service provider computer 120) that the membership is associated with a private vehicle sharing arrangement. The group may also indicate the identify of its members that would be using the membership.

With continued reference to FIG. 1, the memory 124 of the service provider computer(s) 120 may also include a recommendation module 134. In general, the recommendation module 134 may be configured to communicate and/or interface with the retailer computer(s) 144. The recommendation module 134 may be configured to access various information stored in the service provider datastore 142. For example, the recommendation module 134 may access retailer information, retailer profile information, consumer information, consumer profile information, vehicle wholesale information, vehicle retail information, retailer inventory information, and/or the like. As such, the recommendation module 134 may determine, based at least in part on such information, one or more recommendations for vehicles that the retailer should provide to the flexible vehicle sharing program.

For instance, the recommendation module 134 may be configured to access retailer profile information of a retailer to determine a set of vehicles that the retailer has made available to the flexible vehicle sharing program. The recommendation module 134 may also access consumer profile information of various registered consumers 101. In certain embodiments, the accessed consumer profiles may be associated with a particular geographic region. The recommendation module 134 may determine one or more vehicles (e.g., and/or one or more vehicle attributers associated with vehicles) that the respective consumers 101 have indicated a desire to drive. As such, the recommendation module 134 may identify one more matching vehicles that have both been made available by the retailer, and that have been indicated/selected by the consumer 101. The recommendation module 134 may determine, based at least in part on wholesale vehicle information and/or retail vehicle information associated with the identified vehicles, which of the identified vehicles the retailer has a relatively high probability of obtaining a profit on if provided to the flexible vehicle sharing program. For example, in order to determine whether a retailer should provide a particular vehicle (e.g., of the identified vehicles) to the flexible vehicle sharing program, the recommendation module 134 factor in a wholesale price, a retail price, a depreciation value, a probability of selling, residual value, days in the retailer's inventory, an income associated with a consumer selection of the particular vehicle, profitability from continuing to rent the vehicle relative to committing the vehicle to the program (in the case of a rental car company), and/or the like. In certain instances, the recommendation module 134 may determine that for the particular vehicle at a current point in time, providing the particular vehicle to the flexible vehicle sharing program for a predetermined period of time, and then selling the particular vehicle, will result in a higher profit than selling the particular vehicle at the current point in time or, in the case of a rental car company, continuing to rent the vehicle.

Referring again to the service provider computer(s) 120, the one or more network and I/O interfaces 136 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the service provider computer(s) 120, and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 138 may include, but is not limited to, a liquid crystal display, a light-emitted diode display, or an E-Ink™ display as made by E Ink Corp. of Cambridge, Mass. The display 138 may be used to show content to a user in the form of text, images, or video. In certain instances, the display 138 may also operate as a touch screen display that may enable the user to initiate commands or operations by touching the screen using certain finger or hand gestures.

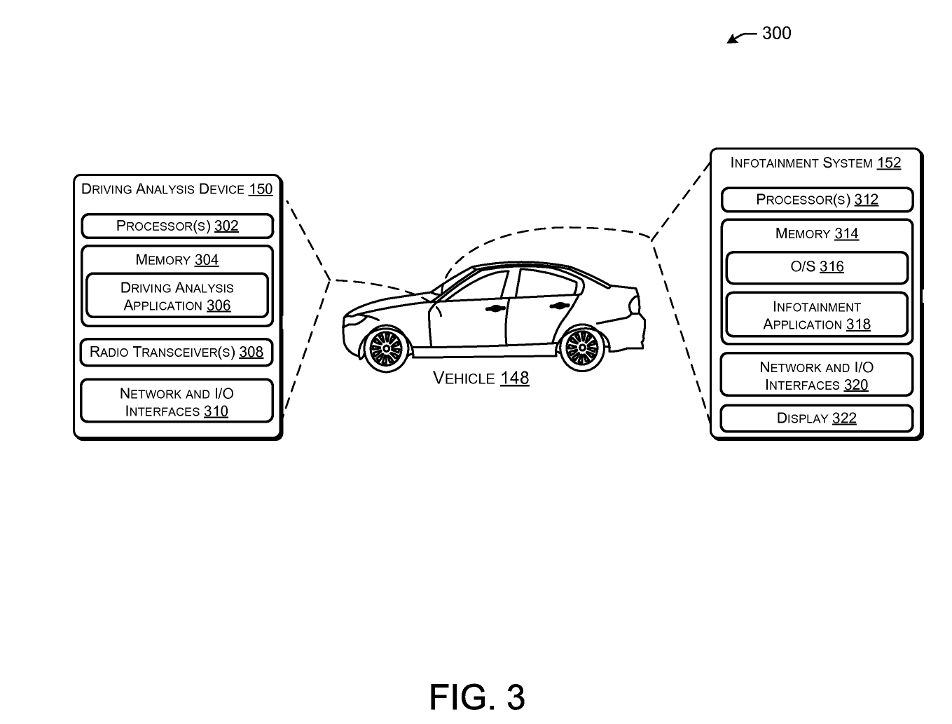

With continued reference to FIG. 1, the system 100 may also include a selected vehicle 148 in communication with the network(s) 118. The selected vehicle 148 may be a vehicle that the consumer 101 has selected to drive and that the consumer 101 is currently in possession of. The selected vehicle 148 may include a driving analysis device 150 and an infotainment system 152, described in more detail with reference to FIG. 3. Additionally, the system 100 may include one or more third-party computer(s) 146 that may be associated with third-part service providers. Third-party service providers may provide any types of services related to collecting vehicle data and/or facilitating the management of vehicle inventory associated with the retailer computer(s) 144, the service provider computer(s) 120, and/or any other devices in communication with the network(s) 118. Third-party computer(s) 146 may also include security and/or access systems configured to facilitate access to and/or operation of the vehicle by a user.

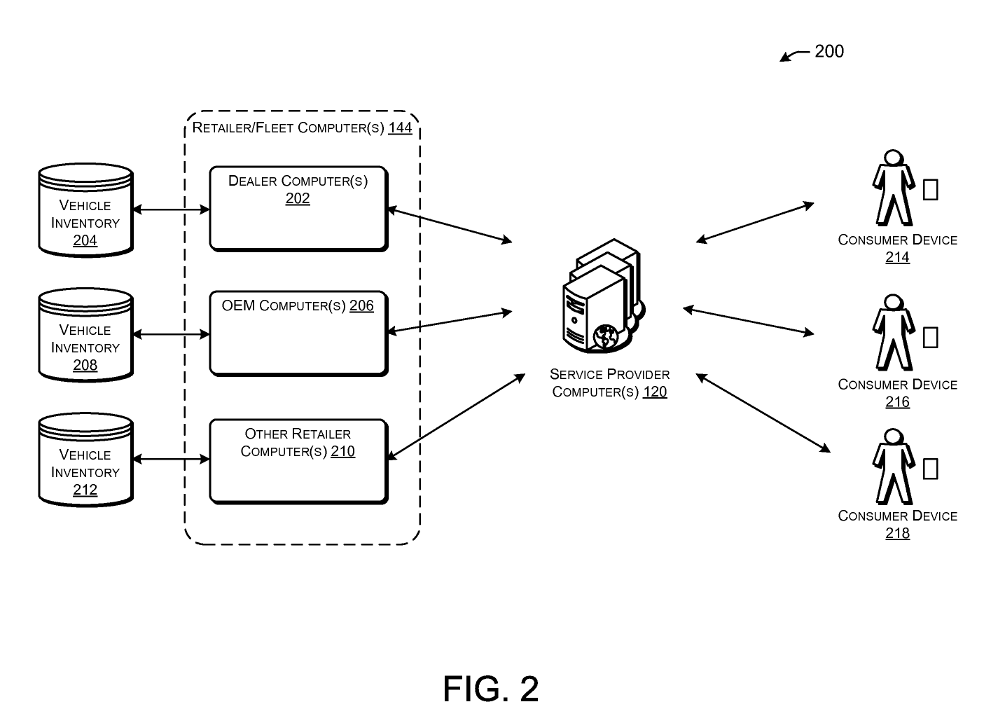

Referring now to FIG. 2, a system 200 illustrating interaction between the retailer computers 144, service provider computer(s) 120, and one or more consumers is provided in accordance with one or more example embodiments. As depicted by the system 200, the retailer computer(s) 144 may include dealer computer(s) 202, OEM computer(s) 206 and/or other retailer computer(s) 210 (which may include, without limitation, rental car companies, finance companies and fleet companies). To this end, each of the dealer computer(s) 202, OEM computer(s) and/or other retailer computer(s) may include respective vehicle inventory 204/208/212.

Furthermore, the system 200 may include multiple consumer devices 214/216/218. One or more service provider computer(s) 120 may provide a flexible vehicle sharing program between the retailer computer(s) 144 and the consumer devices 214/216/218. For instance, the service provider computer 120 may receive, from the retailer computer(s) 144, vehicle identifiers associated with vehicles (from the vehicle inventories 204/208/212) that are to be provided to the flexible vehicle sharing program. In addition, the service provider computer 120 may receive, from the consumer device(s) 214/216/218 and/or their respectively associated consumers, one or more vehicles selections indicating which vehicles the consumers desire to drive.

To this end, the service provider computer 120 may be configured to determine whether the selected vehicles associated with the consumer devices 214/216/218 match any of the provided vehicles of the retailer computer(s) 144. If a match exists, the service provider computer 120 may transmit an indication of the match to retailer computer(s) 144 and/or the consumer device(s) 214/216/218. If the service provider computer 120 receives, from the consumer device(s) 214/216/218, an indication to proceed with the match, the service provider computer 120 may generate an association between the matching vehicle and the consumer device(s) 214/216/218 and may flag and/or otherwise indicate that the matching vehicle is currently in use or “checked out”.

For instance, the service provide computer 120 may be configured to display and/or transmit instructions to the consumer device(s) 214/216/218 to display vehicle inventory that may be available to a consumer 101 (e.g., based on the consumer's subscribed tier). The consumer 101 may then select the desired vehicle from the available vehicle inventory. To this end, the selection may be transmitted (e.g., by the consumer device(s) 102) to the service provider computer(s) 120, and the service provider computer(s) 120 may be configured to forward the selection to the appropriate retailer and/or retailer computer 144.

Furthermore, the service provider computer(s) 120 may transmit an indication to the retailer computer(s) 144 that a vehicle from inventory 204/208/212 has been selected by a consumer in the flexible vehicle sharing program. Additionally, the service provider computer(s) 120 may be configured to remit a payment to the retailer computer(s) 144 in response to the consumer selection of the vehicle from the retailer's inventory. In certain embodiments, the payment may be a flat fee. Alternatively, the payment may equal a percentage of a monthly subscription fee paid by the consumer to the service provider to participate in the flexible vehicle sharing program. In other implementations, the payment may be fixed according to one or more vehicle attributes (e.g., make, model, etc.) associated with consumer-selected vehicle.

FIG. 3 illustrates a system diagram including the driving analysis device 150 and the infotainment system 152 associated with the selected vehicle 148 of FIG. 1. The driving analysis device 150 may include one or more computer processors 302, and a memory 304 storing a driving analysis application 306. In addition, the driving analysis module(s) 150 may include one or more radio transceivers 308 and one or more network and I/O interfaces 310. In certain embodiments, the driving analysis module(s) 150 may include one or more sensors capable of gathering information associated with a present environment of the driving analysis module(s) 150, or similar hardware devices, such as a camera, microphone, antenna, a gesture capture or detection device, or Global Positioning Satellite (GPS) device. The driving analysis device 150 may provide vehicle analytics and may communicate with one or more vehicle computers wirelessly, via-hardwired connection, or via existing ports, such as the onboard diagnostics port (OBD). Such a configuration may facilitate monitoring of mileage, maintenance scenarios, etc. by the driving analysis device 150. Such interfaces may also enable the system to control door locks, an ignition kill switch, and other systems of the vehicle. For example, if a consumer has not paid his/her balance for the vehicle beyond the term, and assuming the vehicle is not in motion, the driving analysis device 150 may kill the vehicle via the ignition kill switch, and may enable the service to determine the vehicle's location for collection. The driving analysis device 150 may be configured to implement rules to ensure that, for instance, the vehicle is not on a roadway (e.g., via GPS positioning) or otherwise a hazard prior to killing the ignition.

The computer processors 302 may comprise one or more cores and may be configured to access and execute (at least in part) computer-readable instructions stored in the memory 304. The one or more computer processors 302 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The driving analysis module 150 may also include a chipset (not shown) for controlling communications between the one or more processors 302 and one or more of the other components of the driving analysis module 150. In certain embodiments, the driving analysis module 150 may be based on an Intel® architecture or an ARM® architecture, and the processor(s) and chipset may be from a family of Intel® processors and chipsets. The one or more processors 302 may also include one or more application-specific integrated circuits (ASICs) or application-specific standard products (ASSPs) for handling specific data processing functions or tasks.

The memory 304 may include one or more computer-readable storage media (CRSM). In some embodiments, the memory 304 may include non-transitory media such as random access memory (RAM), flash RAM, magnetic media, optical media, solid state media, and so forth. The memory 304 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 304 may store an operating system 108 that includes a plurality of computer-executable instructions that may be implemented by the computer processor to perform a variety of tasks to operate the interface(s) and any other hardware installed on the driving analysis module 150. The memory 304 may also store content that may be displayed by the driving analysis module 150 or transferred to other devices (e.g., headphones) to be displayed or played by the other devices. The memory 304 may also store content received from the other devices. The content from the other devices may be displayed, played, or used by the driving analysis module 150 to perform any necessary tasks or operations that may be implemented by the computer processor or other components in the driving analysis module 150.

With continued reference to the driving analysis device 150, the radio transceiver(s) 308 may be any type of receiver and or transceiver capable of receiving and/or transmitting wireless data.

Referring again to the driving analysis device 150, the one or more network and I/O interfaces 310 may include one or more communication interfaces or network interface devices to provide for the transfer of data between the driving analysis device 150 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The driving analysis device 150 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the driving analysis device 150 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

Additionally, as previously discussed, the memory 304 may include a driving analysis application 306. For example, according to one or more embodiments, the driving analysis device 150 may be connected to and/or otherwise in communication with a driving diagnostics port on the selected vehicle 148 (e.g., via the network and I/O interfaces 310 on the driving analysis device 150). As such, the driving analysis application 306 may be configure to monitor one or more driving characteristics of consumer 101 driving the selected vehicle 148. For instance, the driving analysis application 306 may be configured to monitor the average acceleration and/or speed of the selected vehicle 148 while the consumer 101 is driving. In certain embodiments, the driving analysis application 306 may also be configured to track the distance driven, the location of the vehicle, the frequency and/or force with which the brakes are depressed, and/or any other driving characteristics associated with the consumer's 101 driving habits.

Moreover, the driving analysis application 306 may be configured to periodically transmit updated driving characteristics associated with the consumer 101 to the service provider computer(s) 120 (e.g., via the consumer module 132). As such, the consumer module 132 may be configured to determine, based at least in part on the received driving characteristics, one or more discounts and/or rewards that may be provided to the consumer 101 and/or applied to the consumer's 101 account with the flexible vehicle sharing program. For instance, if the consumer module 132 determines that the consumer 101 is a relatively safe driver (e.g., such as by determining that the consumer 101 drives within a predetermined speed range, does not frequently slam on the gas pedal or the brakes, etc.), the consumer module 132 may determine that the consumer 101 is eligible for certain rewards (e.g., discount on the monthly subscription fee, eligible for upgrades to certain peripheral equipment such as GPS, and/or the like).

Furthermore, in certain implementations, the driving analysis device 150 may be integrated into the selected vehicle 148. To this end, the driving analysis device 150 may be configured to place certain limits on the driving capabilities of the vehicle 148. For instance, the driving analysis device 150 may be configured to limit the maximum speed of the vehicle 148 and/or enact any other safety and risk controls on the vehicle 148. In certain implementations, the driving analysis device 150 may also be configured to determine location information associated with the vehicle 148.

With continued reference to FIG. 3, the infotainment system 142 may include one or more computer processors 312, and a memory 314 storing an infotainment application 318. In addition, the infotainment system(s) 152 may include one or more network and I/O interfaces 320 and a display 322. In certain embodiments, the infotainment system(s) 152 may include one or more sensors capable of gathering information associated with a present environment of the infotainment system(s) 152, or similar hardware devices, such as a camera, microphone, antenna, a gesture capture or detection device, or Global Positioning Satellite (GPS) device.

The computer processors 312 may comprise one or more cores and may be configured to access and execute (at least in part) computer-readable instructions stored in the memory 314. The one or more computer processors 312 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The infotainment system 152 may also include a chipset (not shown) for controlling communications between the one or more processors 312 and one or more of the other components of the infotainment system 152. In certain embodiments, the infotainment system 152 may be based on an Intel® architecture or an ARM® architecture, and the processor(s) and chipset may be from a family of Intel® processors and chipsets. The one or more processors 312 may also include one or more application-specific integrated circuits (ASICs) or application-specific standard products (ASSPs) for handling specific data processing functions or tasks.

The memory 314 may include one or more computer-readable storage media (CRSM). In some embodiments, the memory 314 may include non-transitory media such as random access memory (RAM), flash RAM, magnetic media, optical media, solid state media, and so forth. The memory 314 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 314 may store an operating system (O/S) 316 that includes a plurality of computer-executable instructions that may be implemented by the computer processor to perform a variety of tasks to operate the interface(s) and any other hardware installed on the infotainment system 152. The memory 314 may also store content that may be displayed by the infotainment system 152 or transferred to other devices (e.g., headphones) to be displayed or played by the other devices. The memory 314 may also store content received from the other devices. The content from the other devices may be displayed, played, or used by the infotainment system 152 to perform any necessary tasks or operations that may be implemented by the computer processor or other components in the infotainment system 152.

The memory 314 may also include an operating system (O/S) 316, which may provide an interface between other application software executing on the infotainment system 152 and hardware resources of the infotainment system 152. More specifically, the operating system 316 may include a set of computer-executable instructions for managing hardware resources of the infotainment system 152 and for providing common services to other application programs (e.g., managing memory allocation among various application programs). The operating system 316 may include any operating system now known or which may be developed in the future including, but not limited to, any consumer operating system, any server operating system, any mainframe operating system, or any other proprietary or freely available operating system. The infotainment system 152 may also communicate with the service provider computer to communicate messages to the consumer, for instance trade offers, time left with the vehicle, payment reminders, warnings of upcoming maintenance or return notices or deactivation notices, etc.

Referring again to the infotainment system 152, the one or more network and I/O interfaces 320 may include one or more communication interfaces or network interface devices to provide for the transfer of data between the infotainment system 152 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The infotainment system 152 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. For example, the wireless interfaces may include GSM, CDMA, 3G, LTE, LTE-Advanced, Bluetooth, Bluetooth low-energy, near-field communication (NFC) and/or the like. The communication interfaces may utilize acoustic, radio frequency, optical, or other signals to exchange data between the infotainment system 152 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 322 may include, but is not limited to, a liquid crystal display, a light-emitted diode display, or an E-Ink™ display as made by E Ink Corp. of Cambridge, Mass. The display 322 may be used to show content to a user in the form of text, images, or video. In certain instances, the display 322 may also operate as a touch screen display that may enable the user to initiate commands or operations by touching the screen using certain finger or hand gestures.

As previously discussed, the memory 314 may include an infotainment application 318. The infotainment application may be generally configured to provide (e.g. via the display 322, vehicle speakers, and/or other means) a driver (e.g., the consumer 101) with various characteristics about the vehicle 148 and its interior and/or exterior environment. For instance, such information may include data related to temperature both inside and outside the vehicle, mileage, radio settings, volume settings, peripheral device settings, and/or the like.

According to certain embodiments, the infotainment application 318 may communicate with the consumer device(s) 102 and/or the driving analysis device 150 to transmit information to the service provider computer(s) 120. For instance, the infotainment application 318 may be aware of the selected vehicle's 148 location (e.g., GPS coordinates) either through its own calculations and/or via location applications included on consumer device 102 (e.g., the infotainment system 152 may be in direct communication with the consumer device 102 via Bluetooth, Wi-Fi, and/or other similar technology). As such, the vehicle's 148 location may be transmitted to the service provider computer(s) 120 (e.g., to the consumer module 132). In certain implementations, the consumer module 132 may be configured to determine, based at least in part on the selected vehicle's 148 location, one or more advertisements to display to the consumer 101 (e.g., if there is a coffee shop nearby, the consumer module 132 may generate/retrieve an advertisement associated with the coffee shop). Such advertisements can be presented in many forms, including display advertising, audio-visual advertising, or as points of interest on a GPS navigation display or map. The consumer module 132 may then transmit the advertisement(s) to the infotainment system 152 and/or the consumer device 102. Alternatively, the advertisement(s) may be transmitted to the infotainment system 152 only, and the infotainment system may display the advertisement via its display 322 and/or forward the advertisement to the consumer device 102 to be displayed on the consumer device 102.

Using the driving analysis device 150 and infotainment system 152, the service provider computer 120 and/or consumer device can control hardware aspects such as vehicle locks to facilitate access to the vehicle, ignition operability to facilitate use and operation of the vehicle, display of infotainment system to present information to the user, and the like.

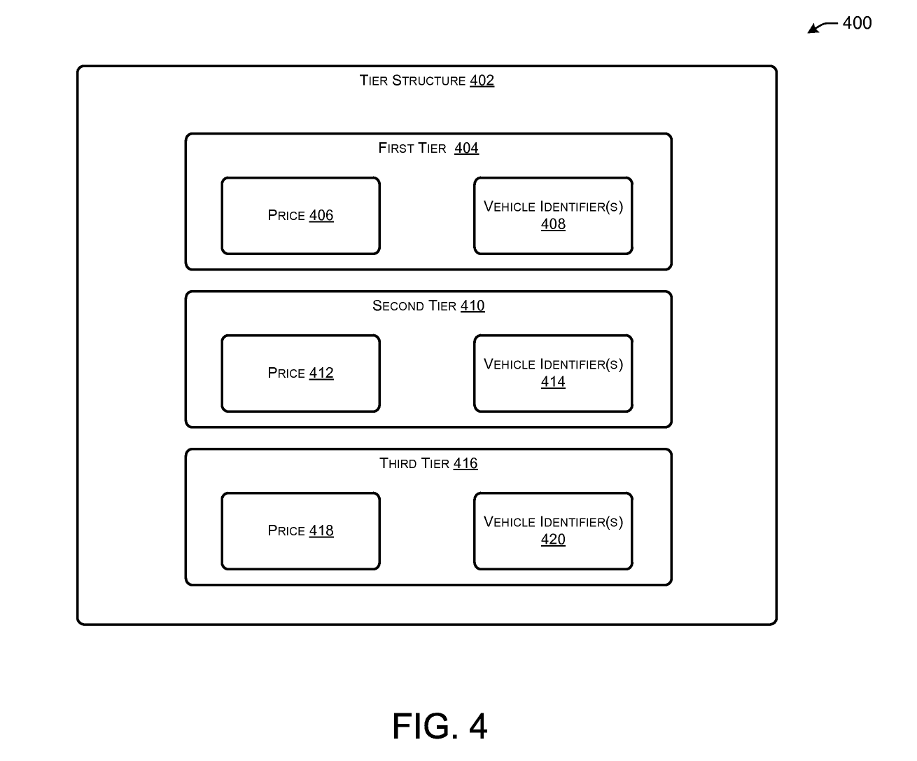

Referring now to FIG. 4, a pricing structure 400 is illustrated for a flexible vehicle sharing program in accordance with one or more example embodiments. The pricing structure 400 may depict a first tier 404, which may be associated with a price 406 and one or more vehicle identifier(s) 408. Furthermore, the pricing structure 400 may also include a second tier 410 associated with its price 412 and vehicle identifier(s) 414, as well as a third tier 416 associated with its own price 418 and vehicle identifier(s) 420. It will be appreciated that while the pricing structure 400 illustrates three tiers, any number of tiers may be contemplated within the present disclosure. Furthermore, each tier may be associated with any number of prices and/or vehicle identifier(s) 408. Alternatively, instead of having tiers, the system may be priced based on the vehicle used, or it could be a dynamically priced system based on, among other things, the vehicle selected, usage of the vehicle, the driving characteristics determined by the driving analysis device 150, the consumer's characteristics (e.g., age, gender, credit score, etc.).

According to one or more embodiments, the prices 406/412/418 may include monthly subscription fees. Alternatively, the prices 406/412/418 may also include “a la carte” prices for consumers 101 who wish to select a vehicle to drive from the respective tier, but who do not wish to subscribe to that respective tier. Furthermore, in some implementations, each tier may be associated with different prices 406/412/418 as well as vehicle identifiers 408/414/420 corresponding to differently priced vehicles. For example, a vehicle identifier 408 associated with a Toyota Corolla may belong to the first tier 404 while a vehicle identifier 420 associated with a BMW 5-Series sedan may belong to the third tier 416.

According to certain embodiments, the prices 406/412/418 may be determined by the service provider computer 120 according to various factors. For instance, the service provider computer(s) 120 may determine a particular price based at least in part on insurance costs for insuring vehicles, maintenance costs associated with the vehicles, and other costs associated with usage of the vehicles. Furthermore, a consumer 101 in a particular vehicle tier 404/410/416 may be given the opportunity to upgrade to a higher tier and/or downgrade to a lower tier depending upon his/her needs for a particular period. In certain instances, in order to move between tiers, the consumer 101 may be charged a fee by the flexible vehicle sharing program. As a result of the change in tiers, the consumer 101 may be able to immediately swap and/or otherwise access the vehicles available in the new tier.

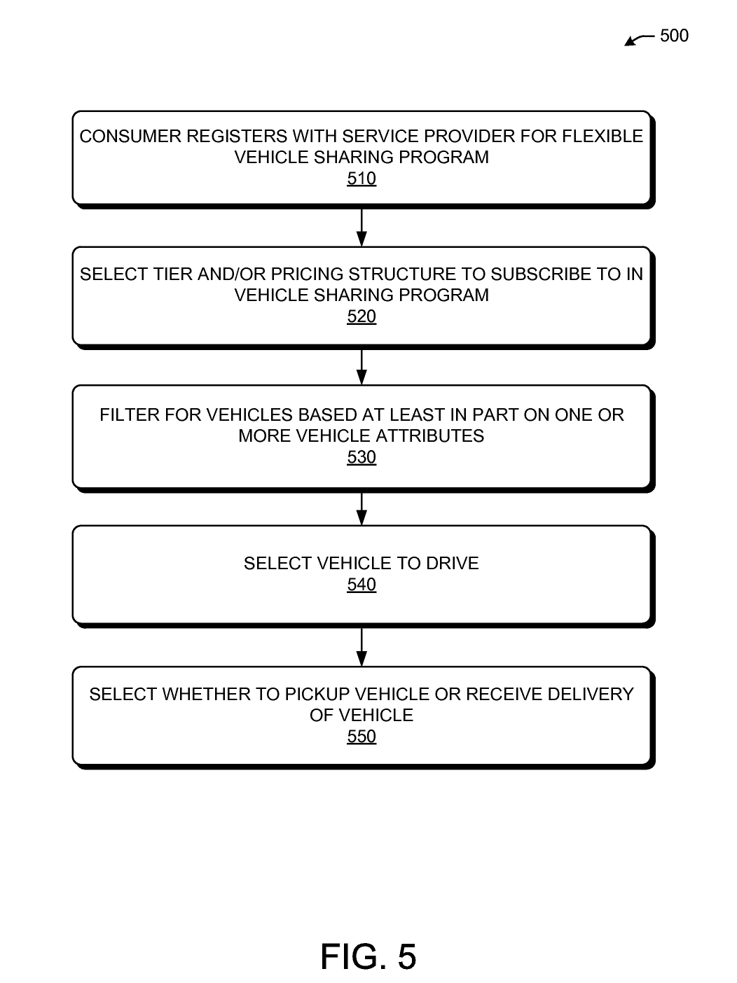

Referring now to FIG. 5 a method 500 is provided for consumer registration and vehicle selection via the flexible vehicle sharing program in accordance with one or more example embodiments. The method 500 may begin in block 510 in which a consumer, such as consumer 101 of FIG. 1 registers with the service provider server for the flexible vehicle sharing program (e.g., the consumer 101 may register via the consumer device 102). It will be appreciated that any action taken by the consumer 101 may be performed via input of the consumer device 102.

In block 520, the consumer 101 may select a tier and/or pricing structure to subscribe to in the vehicle sharing program. As previously discussed, each tier may be associated with respective prices and vehicle identifiers. In block 530, the consumer 101 may filter the vehicle identifiers in the selected tier based at least in part on one or more vehicle attributes (e.g., make, model, trim, year, mileage, options, etc.). In block 540, the consumer 101 may select the vehicle identifier associated with the vehicle the consumer 101 wishes to drive. In block 550, the consumer 101 may select whether to pick up the selected vehicle and/or receive delivery of the selected vehicle.

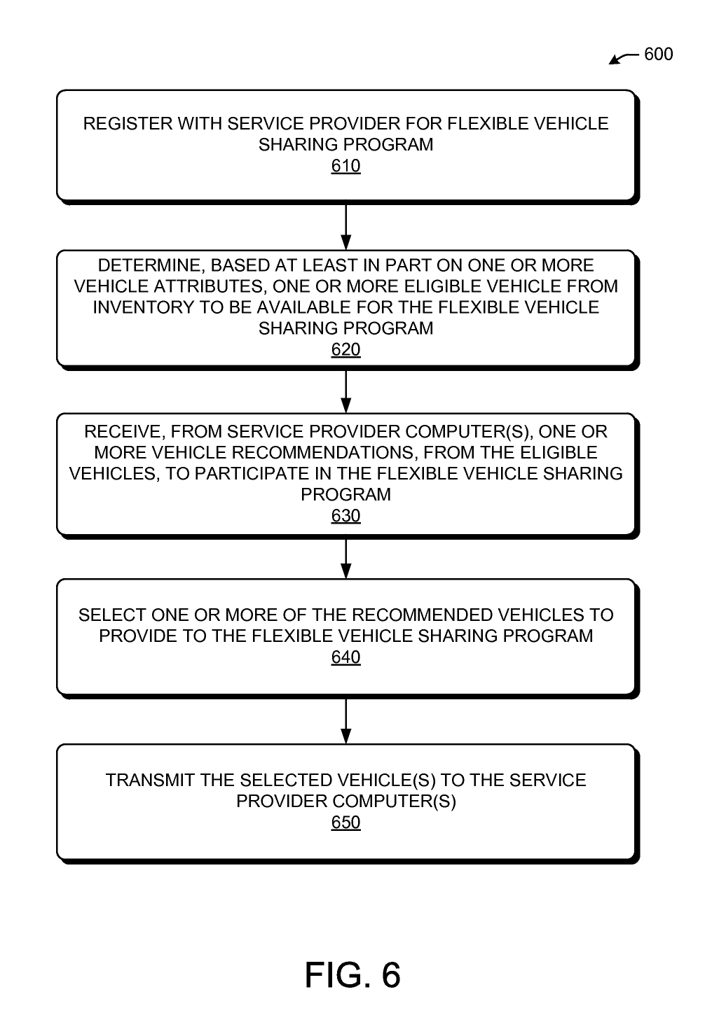

Referring now to FIG. 6 a method 600 is provided for retailer registration and vehicle selection via the flexible vehicle sharing program in accordance with one or more example embodiments. The method 600 may begin in block 610 in which a retailer, such as retailer associated with a retailer computer 144 of FIG. 1 registers with the service provider server for the flexible vehicle sharing program (e.g., the retailer may register via the retailer computer 144). It will be appreciated that any action taken by the retailer may be performed via the retailer computer 144.

In block 620, the retailer computer 144 may determine, based at least in part on one or more vehicle attributes (e.g., selected by the retailer), one or more eligible vehicles from its vehicle inventory to be made available to the flexible vehicle sharing program. In block 630, the retailer computer 144 may receive, from the service provider computer 120, one or more vehicle recommendations (e.g., the recommendations may be based on the eligible vehicles) for vehicles to provide to the flexible vehicle sharing program. In block 640, the retailer and/or retailer computer 144 may select one or more of the recommended vehicles to provide to the flexible vehicle sharing program. In block 650, the retailer computer 144 may transmit the selected vehicle(s) (e.g., the associated vehicle identifiers) to the service provider computer 144.

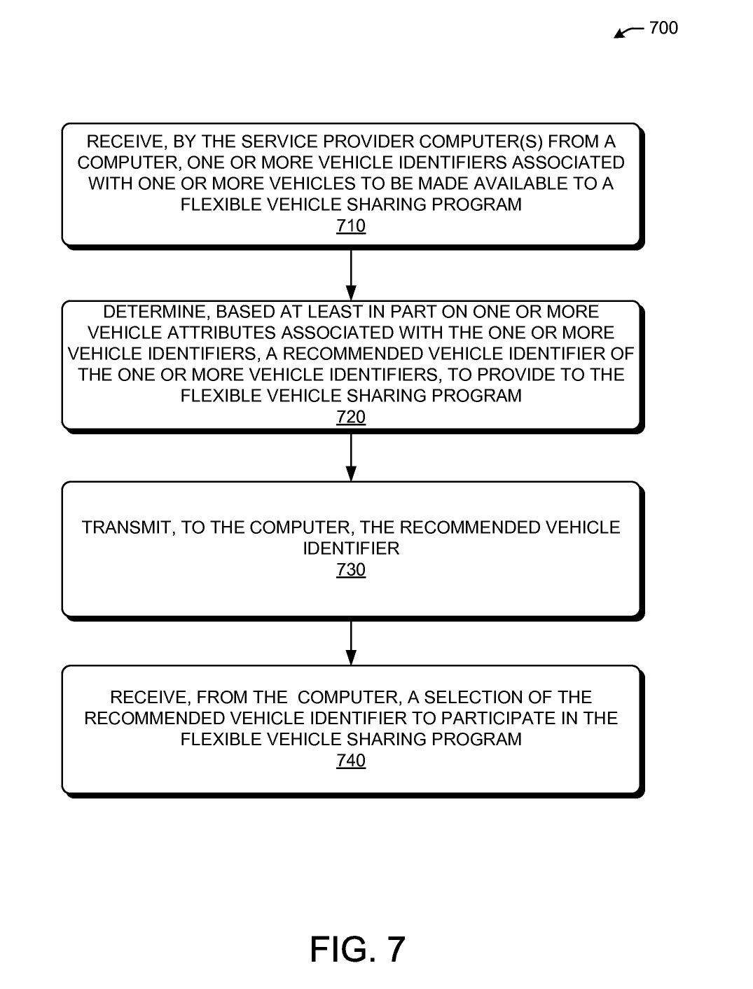

Referring now to FIG. 7, a method 700 is provided for determining one or more vehicles to recommend for the flexible vehicle sharing program in accordance with one or more example embodiments. The method 700 may begin in block 710, in which a service provider computer, such as the service provider computer 144 of FIG. 1, may receive, from a retailer computer, such retailer computer 144 of FIG. 1, one or more vehicle identifiers. The vehicle identifiers may be associated with one or more vehicles that the retailer has designated to be made available to the flexible vehicle sharing program. In block 720, the service provider computer 120 may determine, based at least in part on one or more vehicle attributes associated with the one or more vehicle identifiers, a recommended vehicle identifier to provide to the flexible vehicle sharing program. The recommended vehicle identifier may be selected from the received one or more vehicle identifiers from the retailer computer 144. In block 730, the service provider computer 120 may transmit, to the retailer computer 144, the recommended vehicle identifier. In block 740, the service provider computer 120 may receive, from the retailer computer 144, a selection of the recommended vehicle identifier to participate in the flexible vehicle sharing program.

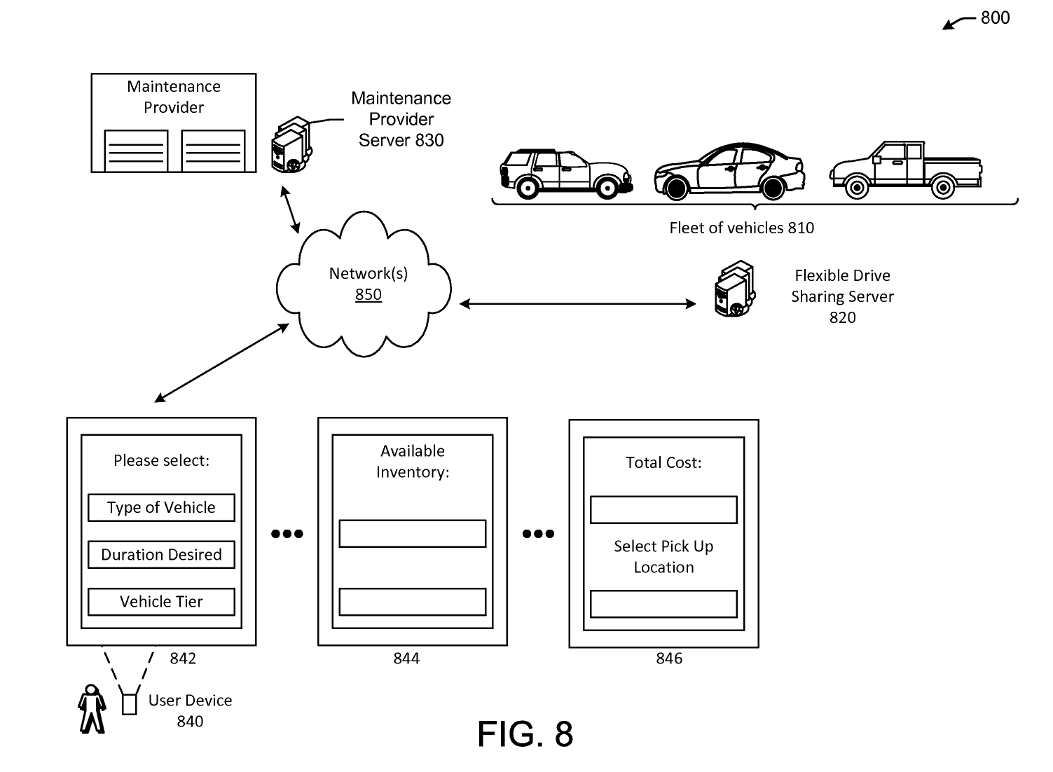

Referring now to FIG. 8, another embodiment of a flexible vehicle sharing system 800 in accordance with the disclosure is illustrated. In the illustrated embodiment, the flexible vehicle sharing system 800 may include a fleet of vehicles 810. The fleet of vehicles 810 may include one or more vehicles of various categories, makes, models, and the like. For example, the fleet of vehicles 810 may include BMW sport utility vehicles, Audi sport utility vehicles, Toyota sedans, and Fiat coupes, or any combination thereof. The fleet of vehicles 810 may be the set of vehicles that are available to drivers or users of the flexible vehicle sharing system 800 at any given time. When a driver or user removes a vehicle from the fleet of vehicles 810, a fleet database may be updated indicating that the specific vehicle is currently in use by the user, as described herein.

The fleet of vehicles 810 may belong to the service provider of the flexible vehicle sharing system 800. The vehicles of the fleet of vehicles 810 may be acquired from a variety of sources. For example, vehicles may be acquired wholesale from auctions. The vehicles may be off-lease vehicles for which secondary markets are weak, or for which resale may be relatively difficult. In some instances, Original Equipment Manufacturers (OEMs) may facilitate transactions such that off-lease or lease returned vehicles are automatically directed to the flexible vehicle sharing system 800 for monetization. Such arrangements may reduce vehicles from the secondary market, which may benefit OEMs. For example, Nissan may arrange for off-lease Nissan Leaf vehicles to be transferred to the flexible vehicle sharing system 800 upon termination of a lease agreement. In certain embodiments, some of the fleet of vehicles 810 may be Certified Pre-Owned and/or other relatively high quality off-lease vehicles acquired at wholesale auctions. In selecting vehicles to add to the fleet of vehicles 810, the flexible vehicle sharing system 800 may consider consumer needs. For example, if the fleet of vehicles 810 is directed towards ride-sharing service drivers (e.g., Uber, Lyft, or the like), the flexible vehicle sharing system 810 may acquire vehicles with economical gas mileage, and/or high safety ratings. In another example, taxi drivers or other livery that chauffer for a living may desire limousines or black sport utility vehicles. Such factors may be considered in building the fleet of vehicles 810. Vehicles of the fleet of vehicles 810 may be enrolled in other services to maximize potential use of the vehicles. Certain vehicles of the fleet of vehicles 810 may be designated to particular classes or groups of members, which may be based at least in part on location. For example, some of the vehicles may be designated for use by a specific hotel or guests of the hotel. Other examples include golf clubs, resorts, universities, apartment complexes, and other membership organizations for use by designated members. In one example, the flexible vehicle sharing system 800 may designate certain vehicles for use by approved ride-sharing service drivers. Accordingly, approved ride-sharing service drivers that do not own cars or that have inadequate cars may rent from the fleet of vehicles designated for such ride-sharing services. In some embodiments, the flexible vehicle sharing system 800 may include vehicles such as boats, aircraft, recreational vehicles, vacation amenities, and other items.

The flexible vehicle sharing system 800 may include a flexible vehicle sharing server 820. The flexible vehicle sharing server 820 may be in communication with each vehicle of the fleet of vehicles 810, a maintenance service provider server 830, and a user device 840 via one or more network(s) 850. Specifically, the flexible vehicle sharing server 820 may be in communication with driving analysis devices of each vehicle. As described herein, the respective driving analysis devices may provide vehicle operation information about driving behavior of users operating the respective vehicle. Vehicle operation information may include average vehicle speed information, speeding above a certain threshold (e.g., over 80 miles per hour, over 90 miles per hour, or another threshold), hard braking incident information, which may be defined as rapid changes in speed or sudden deceleration, or significant brake pedal depression events, and other information related to operation of the vehicle. The flexible vehicle sharing server 820 may utilize the received vehicle operation information to determine a driving behavior profile for respective users. In some embodiments, users may be categorized as “safe drivers,” “aggressive drivers,” or in other categories. In other embodiments, users may be assigned points or other indicators on a per-incident basis and/or ranked accordingly. The driving analysis device may further facilitate access to the vehicle, and may further monitor a location and usage of the vehicle. For example, the driving analysis device may monitor check engine or other maintenance codes output by the vehicle. The driving analysis device may also monitor seatbelt usage information.

The flexible vehicle sharing server 820 may communicate with the maintenance service provider server 830 to send and/or receive maintenance information for specific vehicles. Maintenance information may include requests for specific maintenance, such as oil changes or vehicle diagnostic codes, confirmation of maintenance services performed, and other information related to maintenance of vehicles in the fleet of vehicles 810. The flexible vehicle sharing server 820 may update a maintenance database with maintenance information for each vehicle in the fleet of vehicles 810.

Inventory alerts or notifications may be provided to some or all users upon entry of a new vehicle to the fleet of vehicles 810. Such alerts may also include notifications regarding expected availability of vehicles out for maintenance. Users may accordingly request specific vehicles in advance. In some embodiments, users may be able to reserve particular vehicles before the vehicle is available to the general user base for a fee. For example, users may bid to be the first user to operate a special vehicle.

A user may select one of the vehicles from the fleet of vehicles 810 for use. Usage timeframes may be predetermined or defined by the requesting user, for example between 7 and 28 days. The user may access a database to determine availability of specific vehicles during the requested timeframe. For example, in FIG. 8, a first screen 842 may be presented to the user prompting the user to select a type of vehicle, a duration, and a pricing tier. At a second screen 844, the user may select a vehicle from a set of available vehicles determined based at least in part on the user's requests. At a third screen 846, the user may be presented with pricing based at least in part on the user's selections and driving behavior profile. The user may also be presented with a pickup location at which to pick the vehicle up.

Pricing for the usage of a specific vehicle may be dynamic. Pricing may be based on factors including a tier of the selected vehicle, previous driving behavior or profile of the user, estimated mileage the vehicle will be driven, and the like. Driving behavior of the user may indicate a level of wear placed on vehicles driven by the user, excessive speeding and/or hard braking by the user, an accident history of the user, and the like. Additional factors that may be considered in determining pricing include crime rates in the area the vehicle is to be driven or in areas where the user generally operates vehicles, and subsequent user feedback of vehicles driven by the user for which pricing is being provided. For example, if subsequent users routinely complain that the user leaves vehicles dirty, pricing for the user may be affected. In another example, pricing may be determined based at least in part on a percentage of profit earned by a user driving a vehicle as a taxi. For instance, an Uber driver may use one of the vehicles in the fleet of vehicles 810, and pricing may be a percentage of the profit or revenue earned by the driver while using the vehicle. Pricing may be determined in collaboration with third party vendors, such as Uber.

A user may access one of the vehicles of the fleet of vehicles 810 via, for example, the driving analysis device. For example, the user may utilize a smartphone to communicate via a cellular, NFC, or Bluetooth connection, for example, with the driving analysis device of the vehicle to facilitate unlocking of the vehicle's doors. The user may then enter the vehicle and find the keys inside, or may again utilize the smartphone to operate the vehicle. In other embodiments, the user may receive an RFID card that can communicate with a receiver, such as, but not limited to, the driving analysis device to unlock the vehicle's doors and, potentially, unlock the vehicle ignition.

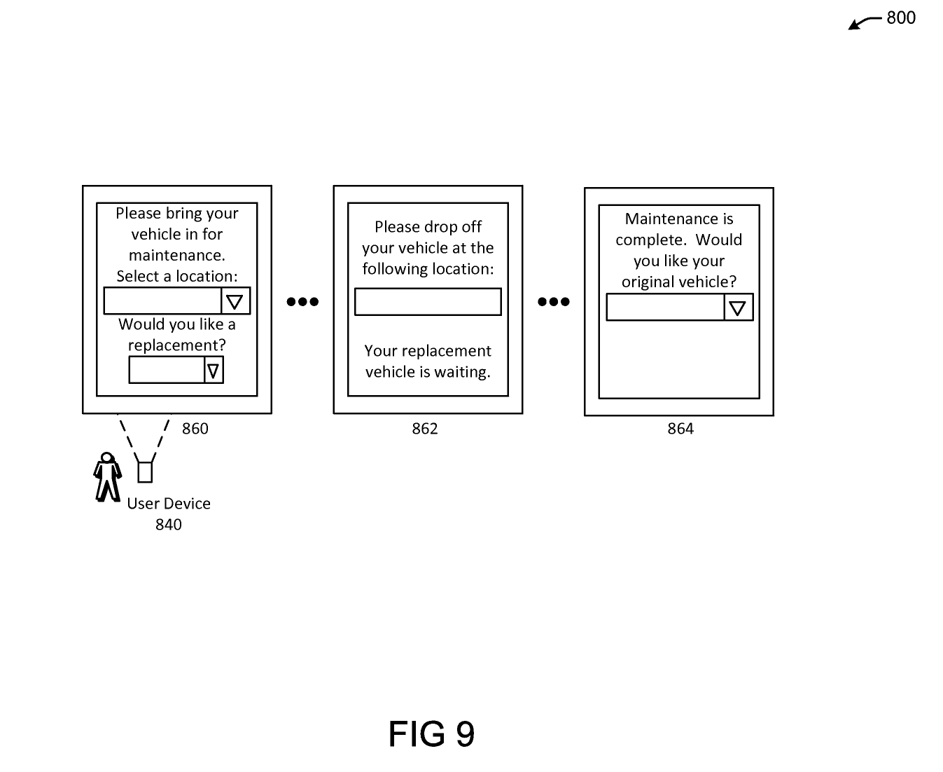

Referring now to FIG. 9, maintenance of one or more vehicles of the fleet of vehicles 810 may be monitored and/or recorded by the flexible vehicle sharing system 800, as described herein. Upon acquisition of a vehicle, the flexible vehicle sharing system 800 may perform initial onboarding of the vehicle into the fleet of vehicles 810. Initial onboarding may include an inspection of the vehicle condition, installation of necessary hardware, such as the driving analysis device 150 and/or sensors to facilitate access by users, and the like. The flexible vehicle sharing system 800 may further identify and/or determine a maintenance record for a vehicle, as well as recommended maintenance. Such determinations may be based at least in part on timing and/or user feedback. For example, oil changes may be recommended every 6 months, or a user may provide feedback regarding poor vehicle performance, which may trigger a maintenance check.

Maintenance may be based at least in part on information received from the driving analysis device. The driving analysis device may provide information such as error or check engine codes, mileage driven, brake pad wear, and the like. The flexible vehicle sharing system 800 may receive the vehicle information and may schedule the user to drop the vehicle off at a predetermined location for maintenance. For example, at a first screen 860 in FIG. 9, the user may receive a request to bring the user's vehicle to a maintenance service provider for maintenance. The user may request a replacement vehicle. At a second screen 862, the user may accept the request to bring the vehicle in for maintenance and may be provided with a maintenance service provider location. At a third screen 864, the user may receive a maintenance confirmation notification, indicating that maintenance is complete. The user may receive an account credit for bringing the vehicle in for maintenance, or may otherwise obtain a replacement vehicle.

In other embodiments, the flexible vehicle sharing system 800 may provide the user with the opportunity to select a new vehicle, and may further designate a pickup location. In some instances, the flexible vehicle sharing system 800 may arrange for drop off of the replacement vehicle while the primary vehicle is collected for maintenance operations. Accordingly, users can effectively always have maintained vehicles. In another use case, the flexible vehicle sharing system 800 may facilitate identification of vehicle recalls and facilitate related maintenance. The flexible drive sharing server may receive recall notices for vehicles that are in the service's fleet. Upon receiving such recall notices, the flexible drive sharing server may determine whether the recall is for an imminent safety issue, in which case it may push a maintenance notification to the user to schedule a vehicle exchange or immediate vehicle service.

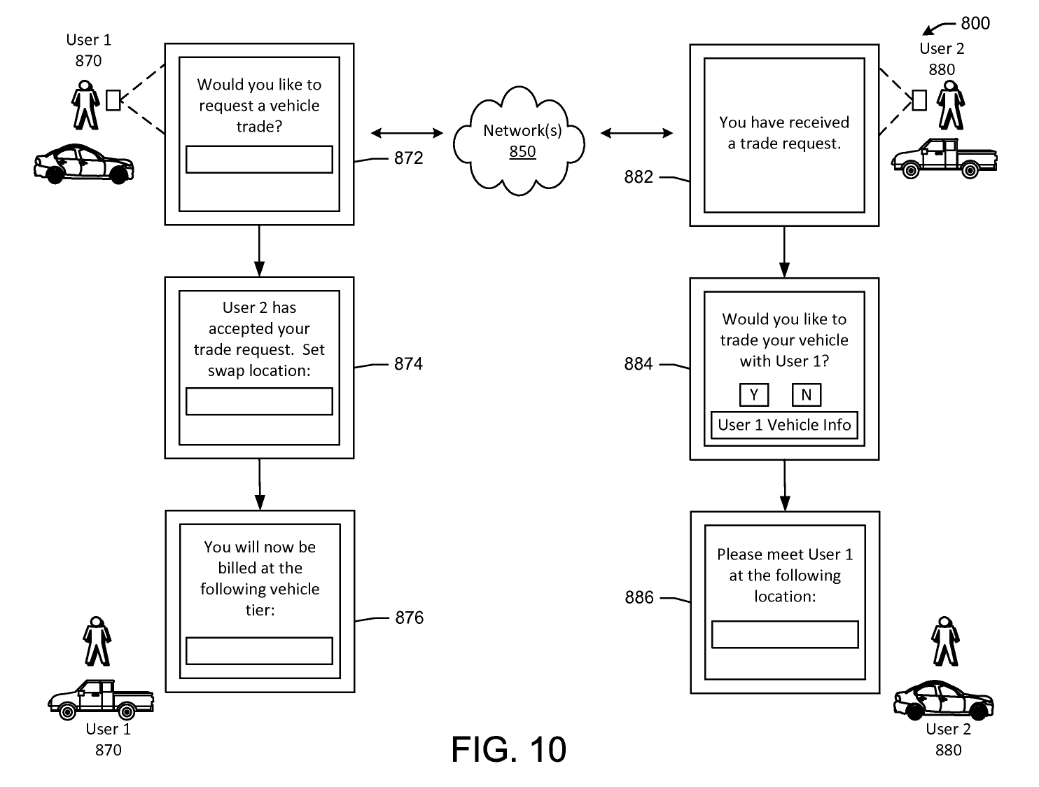

Referring now to FIG. 10, in another embodiment of the flexible vehicle sharing system 800, users of the flexible vehicle sharing system 800 may desire to swap or switch vehicles with other users. For example, a first user 870 with a sedan may desire to swap the sedan with a second user 880 that has a sport utility vehicle. The flexible vehicle sharing system 800 may be configured to facilitate swapping of cars amongst users. The flexible vehicle sharing system 800 may include member-to-member messaging to facilitate communication amongst members or users of the flexible vehicle sharing system 800. The flexible vehicle sharing system 800 may provide a user interface configured to facilitate trade requests amongst users and may provide information regarding vehicles available for swapping. For example, if a user is open to a vehicle swap, the user may opt in to making the user's vehicle available for trade requests from other users. In FIG. 10, the first user 870 with the sedan may send the second user 880 a trade request for the second user's sport utility vehicle by indicating interest at a first screen 872. The second user 880 may receive the request at a second screen 882 and may approve the trade request at a third screen 884. The first user 870 may receive confirmation of the trade acceptance at a fourth screen 874.

The flexible vehicle sharing system 800 may facilitate the vehicle swap by suggesting a swapping time and location, based at least in part on the locations of the first and second users. Example swap or exchange locations may include locations associated with the flexible vehicle sharing system 800, such as car washes. For example, at a fifth screen 886, the second user 880 may receive a vehicle exchange location information. At a sixth screen 876, the first user 870 may receive pricing adjustment information which may reflect an increase or decrease, depending on the tier and/or pricing of the second vehicle, of pricing for using the second vehicle. In some embodiments, the flexible vehicle sharing system 800 may receive a first arrival notification from the first user device indicating that the first user has arrived at the vehicle exchange location. The flexible vehicle sharing system 800 may receive a second arrival notification from the second user device indicating that the second user has arrived at the vehicle exchange location. Based at least in part on the first arrival notification and the second arrival notification, the flexible vehicle sharing system 800 may send a first access signal to the first user device configured to facilitate access to the second vehicle via the first user device. The flexible vehicle sharing system 800 may send, based at least in part on the first arrival notification and the second arrival notification, a second access signal to the second user device configured to facilitate access to the first vehicle via the second user device.

Trade requests can include duration information, compensation information, and user pricing information. For example, trade requests can be for a number of hours, or a number of days. Trade requests can include compensation information in situations where one vehicle is significantly more valuable or otherwise more desirable than the other vehicle. For example, if the first user has a Toyota Corolla, and the second user has a Range Rover, the first user may compensate the second user with a mutually agreed upon amount of compensation. In other embodiments, the second user may be charged at the lower tier pricing for the Toyota Corolla while the first user operates the Range Rover, and vice versa. Swapping arrangements may effectively facilitate subleasing or subletting of a user's vehicle to another user. Users may choose to rent their flex drive vehicle to another user either via the flexible vehicle sharing system 800 or another platform. Such arrangements may subsidize a user's monthly pricing or subscription fees. The first and second users 870, 880 may be able to provide user feedback regarding each other with respect to a cleanliness of the received vehicle, timeliness, and other user feedback.

In an example embodiment of a subleasing arrangement, the flexible vehicle sharing system 800 may receive a vehicle availability notification from the first user device indicating that the first vehicle is available for a period of time. For example, the first user may be on vacation and may wish to sublease his or her vehicle during the duration of vacation. The flexible vehicle sharing system 800 may present a set of available vehicles to a fourth user via a fourth user device. The set of available vehicles may include the first vehicle, as well as other vehicles that are available for use or sublease during a requested timeframe provided by the fourth user. The fourth user may select one of the available vehicles and send a reservation request. The flexible vehicle sharing system 800 may receive the reservation request from the fourth user device, the reservation request indicating that the fourth user is requesting to reserve the first vehicle. The flexible vehicle sharing system 800 may transmit an access signal to the first vehicle configured to facilitate access of the first vehicle by the fourth user. The first vehicle may receive the access signal and may be removed from the set of available vehicles upon being reserved by the fourth user. The flexible vehicle sharing system 800 may transmit an access confirmation signal to the fourth user device configured to enable the first vehicle to become accessible upon the first vehicle receiving the access confirmation signal from the fourth user device. The fourth user may then approach the vehicle, either at a designated location or at a location the first user parked the vehicle, and may access and operate the first vehicle with the access confirmation signal.

In another embodiment, the flexible vehicle sharing system 800 may be configured to allow flexibility in accessing vehicles for use by a subscriber or user. For example, a user may drive a first vehicle to an original airport, leave the first vehicle at the airport for pickup by a second user, fly to a destination airport, pick up a second vehicle at the destination airport, return the second vehicle at the destination airport, fly back to the original airport, and pick up a third vehicle at the original airport to drive home.

The flexible vehicle sharing system 800 may further include a rewards or loyalty program in which users are awarded points or other compensation for factors such as length of membership, driving safety or behavior, tier level of vehicle selected, and the like.

The flexible vehicle sharing system 800 may be configured to maximize resale value of each vehicle in the fleet of vehicles. The flexible vehicle sharing system 800 may actively monitor an equity position in each vehicle, a wholesale value of the vehicle, a retail value of the vehicle, revenue projections for keeping the vehicle in the fleet, depreciation of the vehicle, and projected maintenance costs in order to maximize resale value. Based at least in part on these factors, the flexible vehicle sharing system 800 can determine when to divest vehicles most profitably. Further, the flexible vehicle sharing system 800 can maintain any vehicle in its fleet as “for sale” with a dynamically determined price. That is, while a vehicle is with a user, the vehicle may also be listed for sale, and the pricing for that vehicle may be constantly or periodically updated to account for usage, condition, market conditions, driver abuse, and the like. Users that allow test-drives of their vehicles for potential buyers may be compensated on a per test-drive basis, for example with a credit to their account. Accordingly, the flexible vehicle sharing system 800 may effectively sell the vehicles in the fleet of vehicles 810 while the vehicles are in use.

For example, the flexible vehicle sharing system 800 may receive a vehicle purchase request from a first user device, the vehicle purchase request indicative of a request to purchase the first vehicle, and may generate a vehicle purchase price indicative of a cost to purchase the first vehicle based at least in part on the monitored driving behavior of the first vehicle. The flexible vehicle sharing system 800 may further incorporate maintenance records and/or a service history of a vehicle in generating a vehicle purchase price. The flexible vehicle sharing system 800 may receive an indication of acceptance of the vehicle purchase price from the third user device, and may send a vehicle sold notification to a current user of the vehicle indicating the vehicle is sold.

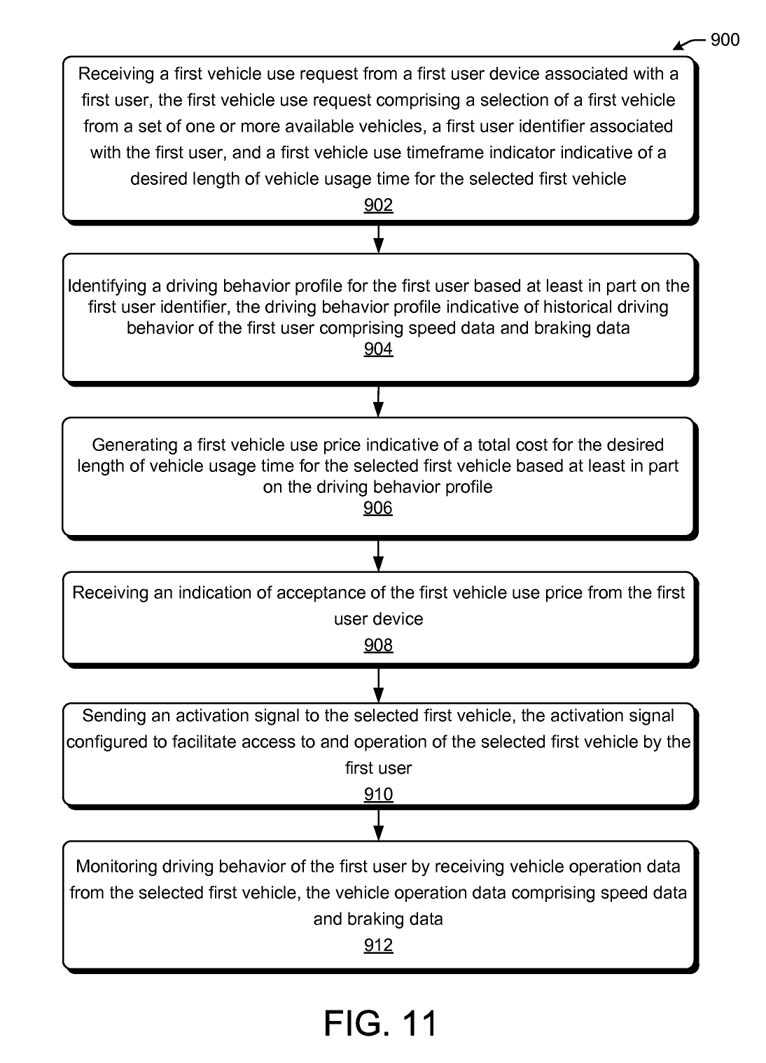

Referring now to FIG. 11, an example method 900 is provided. At block 902, the method 900 includes receiving a first vehicle use request from a first user device associated with a first user, the first vehicle use request comprising a selection of a first vehicle from a set of one or more available vehicles, a first user identifier associated with the first user, and a first vehicle use timeframe indicator indicative of a desired length of vehicle usage time for the selected first vehicle. At block 904, the method 900 includes identifying a driving behavior profile for the first user based at least in part on the first user identifier, the driving behavior profile indicative of historical driving behavior of the first user comprising speed data, braking data, and user feedback data. Block 906 of the method includes generating a first vehicle use price indicative of a total cost for the desired length of vehicle usage time for the selected first vehicle based at least in part on the driving behavior profile. At block 908, the method 900 includes receiving an indication of acceptance of the first vehicle use price from the first user device. Block 910 includes sending an activation signal to the selected first vehicle, the activation signal configured to facilitate access to and operation of the selected first vehicle by the first user. At block 912, the method 900 includes monitoring driving behavior of the first user by receiving vehicle operation data from the selected first vehicle, the vehicle operation data comprising speed data and braking data.

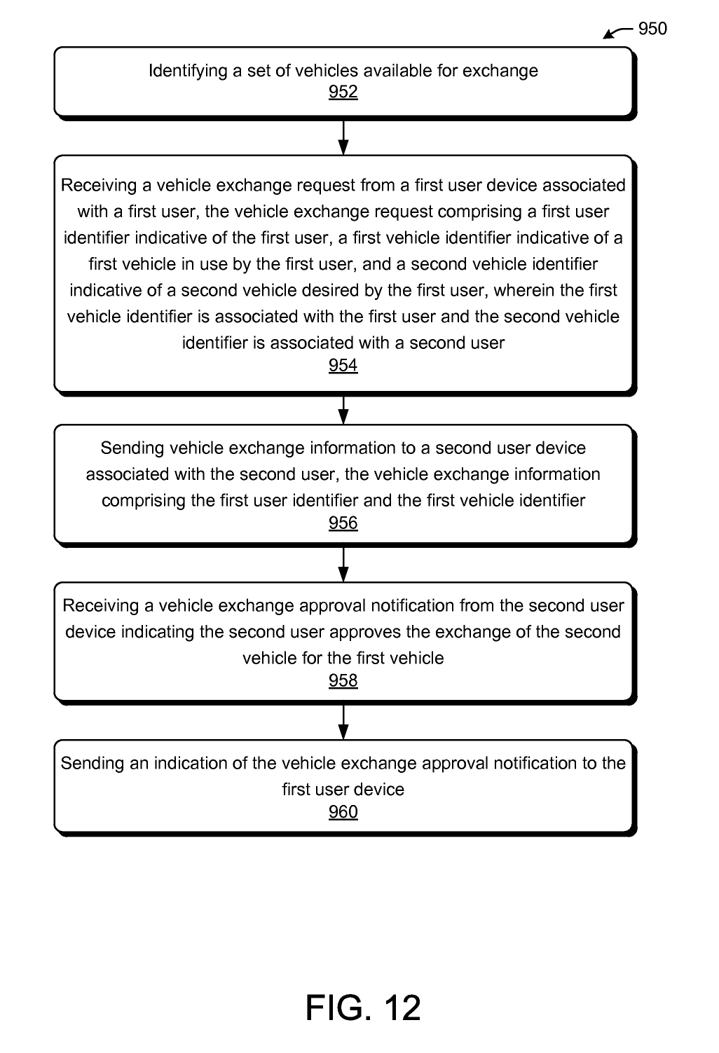

Referring now to FIG. 12, another method 950 is provided. At block 952, the method 950 includes identifying a set of vehicles available for exchange. Block 954 includes receiving a vehicle exchange request from a first user device associated with a first user, the vehicle exchange request comprising a first user identifier indicative of the first user, a first vehicle identifier indicative of a first vehicle in use by the first user, and a second vehicle identifier indicative of a second vehicle desired by the first user, wherein the first vehicle identifier is associated with the first user and the second vehicle identifier is associated with a second user. Block 956 includes sending vehicle exchange information to a second user device associated with the second user, the vehicle exchange information comprising the first user identifier and the first vehicle identifier. Block 958 includes receiving a vehicle exchange approval notification from the second user device indicating the second user approves the exchange of the second vehicle for the first vehicle. Block 960 includes sending an indication of the vehicle exchange approval notification to the first user device. In some embodiments, the second user may be able to request return of the second vehicle from the first user. In such embodiments, the second user may select a third vehicle to operate upon return of the second vehicle. Accordingly, vehicle exchanges may not be direct or one-for-one exchanges, as an entirely different third vehicle may be included. The systems described herein may notify the first and second users when the switch or exchange is available based on when the third vehicle is ready for pick up by the second user.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
receiving, by a computer system comprising one or more processors and a memory, a first vehicle use request from a first user device associated with a first user, the first vehicle use request comprising a selection of a first vehicle from a set of one or more available vehicles, a first user identifier associated with the first user, and a first vehicle use timeframe indicator indicative of a desired length of vehicle usage time for the selected first vehicle;
identifying, by the computer system, a driving behavior profile for the first user based at least in part on the first user identifier, the driving behavior profile indicative of historical driving behavior of the first user comprising speed data and braking data;
generating, by the computer system, a first vehicle use price indicative of a total cost for the desired length of vehicle usage time for the selected first vehicle based at least in part on the driving behavior profile;
receiving, by the computer system, an indication of acceptance of the first vehicle use price from the first user device;
sending, by the computer system, an activation signal to the selected first vehicle, the activation signal configured to facilitate access to and operation of the selected first vehicle by the first user; and
monitoring, by the computer system, driving behavior of the first user by receiving vehicle operation data from the selected first vehicle, the vehicle operation data comprising speed data and braking data.

2. The method of claim 1, further comprising modifying, by the computer system, the driving behavior profile for the first user based at least in part on the monitored driving behavior of the first user.

3. The method of claim 2, further comprising:
receiving, by the computer system, a second vehicle use request from the first user device, the second vehicle request comprising a selection of a second vehicle from the set of one or more available vehicles and a second vehicle use timeframe indicator;
identifying, by the computer system, the modified driving behavior profile of the first user; and
generating, by the computer system, a second vehicle use price based at least in part on the modified driving behavior profile of the first user.

4. The method of claim 1, further comprising:
receiving, by the computer system, a vehicle purchase request from a second user device, the vehicle purchase request indicative of a request to purchase the first vehicle;
generating, by the computer system, a vehicle purchase price indicative of a cost to purchase the first vehicle based at least in part on the monitored driving behavior of the first vehicle by the first user.

5. The method of claim 1, further comprising:
receiving, by the computer system, a maintenance notification from the selected first vehicle, the maintenance notification comprising vehicle maintenance information; and
sending, by the computer system, a maintenance indicator to the first user device, the maintenance indicator comprising maintenance service provider location information.

6. The method of claim 5, further comprising:
receiving, by the computer system, a maintenance confirmation indication from either a maintenance service provider device or the selected first vehicle; and
adjusting the first vehicle use price upon receiving the maintenance confirmation indication.

7. The method of claim 6, further comprising:
updating, by the computer system, a service history of the first vehicle based at least in part on the maintenance confirmation indication; and
generating, by the computer system, a vehicle purchase price indicative of a cost to purchase the first vehicle based at least in part on the service history of the first vehicle.

8. The method of claim 5, further comprising:
sending, by the computer system, a vehicle exchange request to the first user device, the vehicle exchange request comprising a selection of a third vehicle from the set of one or more vehicles;
determining, by the computer system, a location of the selected first vehicle;
determining, by the computer system, a vehicle exchange location based at least in part on the location of the selected first vehicle; and
sending, by the computer system, the vehicle exchange location to the first user device.

9. The method of claim 1, wherein the activation signal sent to the first vehicle by the computer system is configured to facilitate use of the selected first vehicle upon receiving, by a driving analysis system on the first vehicle, a corresponding activation signal from a user device associated with the first user.

10. The method of claim 1, further comprising:
receiving, by the computer system, an indication that usage of the selected first vehicle by the first user is complete after the first vehicle use timeframe is complete; and
receiving, by the computer system, user feedback information regarding the selected first vehicle from a second user device, the user feedback information comprising cleanliness information and timeliness information.

11. A method comprising:
identifying, by a computer system comprising one or more processors and a memory, a set of vehicles available for exchange;
receiving, by the computer system, a vehicle exchange request from a first user device associated with a first user, the vehicle exchange request comprising a first user identifier indicative of the first user, a first vehicle identifier indicative of a first vehicle in use by the first user, and a second vehicle identifier indicative of a second vehicle desired by the first user, wherein the first vehicle identifier is associated with the first user and the second vehicle identifier is associated with a second user;
sending, by the computer system, vehicle exchange information to a second user device associated with the second user, the vehicle exchange information comprising the first user identifier and the first vehicle identifier;
receiving, by the computer system, a vehicle exchange approval notification from the second user device indicating the second user approves the exchange of the second vehicle for the first vehicle; and
sending, by the computer system, an indication of the vehicle exchange approval notification to the first user device.

12. The method of claim 11, further comprising:
determining, by the computer system, a difference in vehicle use pricing between the first vehicle and the second vehicle based at least in part on the first vehicle identifier and the second vehicle identifier; and
adjusting, by the computer system, a user account for the second user to reflect the difference in vehicle use pricing.

13. The method of claim 11, further comprising:
determining, by the computer system, a first location of the first user device and a second location of the second user device;
based at least in part on the first location and the second location, determining, by the computer system, a vehicle exchange location at which the first user and the second user can exchange vehicles;
receiving, by the computer system, a first arrival notification from the first user device indicating that the first user has arrived at the vehicle exchange location;
receiving, by the computer system, a second arrival notification from the second user device indicating that the second user has arrived at the vehicle exchange location;
based at least in part on the first arrival notification and the second arrival notification, sending, by the computer system, a first access signal to the first user device configured to facilitate access to the second vehicle via the first user device;
based at least in part on the first arrival notification and the second arrival notification, sending, by the computer system, a second access signal to the second user device configured to facilitate access to the first vehicle via the second user device; and
receiving, by the computer system, vehicle exchange confirmation from the first user device, the vehicle exchange confirmation indicating that the first user is using the second vehicle and the second user is using the first vehicle.

14. The method of claim 13, further comprising:
monitoring, by the computer system, driving behavior of the second user in the first vehicle;
receiving, by the computer system, a vehicle purchase request from a third user device, the vehicle purchase request indicative of a request to purchase the first vehicle; and
generating, by the computer system, a vehicle purchase price indicative of a cost to purchase the first vehicle based at least in part on monitored driving behavior of the second user in the first vehicle.

15. The method of claim 14, further comprising:
receiving, by the computer system, acceptance of the vehicle purchase price from the third user device; and
sending, by the computer system, a vehicle sold notification to the second user device indicating the first vehicle is sold.

16. The method of claim 15, further comprising:
sending, by the computer system, a vehicle exchange request to the second user device, the vehicle exchange request comprising a selection of a third vehicle from the set of one or more vehicles;
determining, by the computer system, a location of the first vehicle;
determining, by the computer system, a vehicle exchange location based at least in part on the location of the first vehicle; and
sending, by the computer system, the vehicle exchange location to the second user device.

17. The method of claim 15, further comprising:
generating, by the computer system, a vehicle pick up location for the third user to pick up the first vehicle based at least in part on a first vehicle location and a third user device location.

18. The method of claim 13, further comprising:
receiving, by the computer system, a maintenance notification from the first vehicle, the maintenance notification comprising vehicle maintenance information; and
sending, by the computer system, a maintenance indicator to the second user device, the maintenance indicator comprising maintenance service provider location information.

19. The method of claim 18, further comprising:
receiving, by the computer system, a maintenance confirmation indication from either a maintenance service provider device or the first vehicle; and
adjusting, by the computer system, a user account for the second user to reflect a vehicle use pricing credit for vehicle maintenance.

20. The method of claim 19, further comprising:
updating, by the computer system, a service history of the first vehicle based at least in part on the maintenance confirmation indication; and
generating, by the computer system, a vehicle purchase price indicative of a cost to purchase the first vehicle based at least in part on the service history of the first vehicle.

21. The method of claim 11, further comprising:
receiving, by the computer system, a vehicle availability notification from the first user device indicating that the first vehicle is available for a period of time;
presenting, by the computer system, a set of available vehicles to a fourth user via a fourth user device, the set of available vehicles comprising the first vehicle;
receiving, by the computer system, a reservation request from the fourth user device, the reservation request indicating that the fourth user is requesting to reserve the first vehicle; and
transmitting, by the computer system, an access signal to the first vehicle configured to facilitate access of the first vehicle by the fourth user; and
transmitting, by the computer system, an access confirmation signal to the fourth user device configured to enable the first vehicle to become accessible upon the first vehicle receiving the access confirmation signal from the fourth user device.
